(19) United States
(12) Patent Application Publication
(10) Pub. No.: US 2005/0104301 A1
(43) Pub. Date: May 19, 2005

(54) Sealing system for a solenoid

(76) Inventor: Stephen A. Carter, Calgary (CA)

Correspondence Address: Sean W. Goodwin;GOODWIN McKAY, Suite 360, 237-8th Avenue S.E., Calgary, AB, T2G 5C3, CA

(21) Appl. No.: 10/989,308

(22) Filed: Nov. 17, 2004

Related U.S. Application Data
(60) Provisional application No. 60/520,680, filed on Nov. 18, 2003.

(51) Int. Cl. F16J 15/18

(52) U.S. Cl. 277/530

(57) ABSTRACT

A sealing system for a solenoid, typically for use with high pressures and for small molecule gases, utilizes a piston having a hemispherical sealing face in combination with an insert having a sharp edged seat, the piston and the insert both being aligned in a bore having a common centerline to provide repeated reliable mating and sealing of the piston and the insert. Either the sealing face or the insert is made of a plastically deformable elastomeric material which is initially deformed to seal against the other, which is typically metal. The elastomeric is chosen so as to have a finite plastic deformation and not to yield further under design pressures

### CROSS REFERENCE TO RELATED APPLICATION

This application is a regular application claiming priority of U.S. Provisional Patent application Ser. No. 60/520,680 filed on Nov. 18, 2003, the entirety of which is incorporated herein by reference.

### FIELD OF THE INVENTION

Embodiments of the invention relate to sealing systems for valves, such as solenoids, and more particularly to solenoids used to control the flow of small molecule gases under high pressure.

### BACKGROUND

Conventional solenoid designs share many common attributes. Specifically, a magnetic piston, or armature, is opened by an electromagnetic coil surrounding and concentric with the piston. When the coil is electrically de-energized, a compression spring urges the piston towards its closed position. In the no flow state, fluid flow from a seal seat is prevented by the piston and spring forcing a hard seat or sealing lip against an elastomeric seal, such as a rubber or plastic seal.

Typically, the design demands on the elastomer used for the elastomeric seat become increasingly more extreme as the pressure or temperature ranges increase, as the fluid viscosity is lowered, or as the required life expectancy is increased. For example, hydrogen at 1 to 350 bar is much harder to seal than water at 0.2 to 4 bar. Further, the presence of contaminants within the fluid flow present additional challenges to obtaining suitable sealing.

Conventionally, alterations in the seal depth are used to reduce the strain in the elastomer and are typically used when the seal is made of an engineering plastic or with rubber seals and such alterations are suitable when the operating pressure is relatively low.

Rubber seals are typically the most compliant seals, and thus are the most forgiving of surface imperfections in the seat and solid contaminants in the fluid. However, rubber seals are generally limited to lower pressures and less extreme temperatures. At higher pressures, rubber seals may be subject to explosive decompression and/or extrusion. At low temperatures, rubber materials become glass-like and are no longer able to seal.

Plastic seals tend to be less forgiving of surface imperfections than rubber, but are more durable than rubber seals and tend to have wider useful temperature ranges. Due to their harder nature, plastics tend to perform better with liquids and at lower pressures. Seals made from more compliant plastics however, tend to exhibit a cold flow or creep phenomenon, where the seal will eventually extrude and then leak at stress levels far below the materials yield strength. Thus, most plastics have had limited success at high pressure with small molecule gases.

With either elastomer class, rubber or plastic, the choice of sealing lip and piston geometry requires making compromises. As the surface finish and shape is improved, being the flatness or sphericity or conicality of the sealing lip, the performance of the sealing joint improves. However, improving these features to effect better sealing adds cost and the resultant finely-finished parts may be easily damaged by common place events, such as jarring or brushing against other parts. Thus, the overall cost of the apparatus is increased significantly.

Decreasing the lip width will increase the contact and may improve the immediate sealing capability, but is likely to degrade the long-term life expectancy of the seal. For example, in the extreme, a very narrow lip approaches a knife-like edge and will cut the seal material.

The potential for solid particles, typically contaminants, to exist in the fluid stream must also be considered. As high velocity particles can erode away some types of materials, fluid cleanliness and velocity ranges influence seal placement and material selection. Naturally, harder seal materials are less likely to seal with imperfect, eroded surfaces.

As the maximum allowable leak rate for a 350 bar hydrogen valve would be reached or exceeded if a surface imperfection of 5μ-inch existed, it can be concluded that achieving the required seal performance would be borderline or beyond the performance capability of conventionally machined parts. That is to say, the most accurately and precisely machined parts possible would still rely largely on the compliance of the elastomer seal to offset the potential leak past native surface imperfections.

Clearly what is required is a sealing system that is capable of effecting an optimum seal when used with small molecule gas in a high pressure and/or temperature environment. Further, it is desired that the sealing system be more economical than those currently available.

### SUMMARY OF THE INVENTION

Embodiments of the invention define an on-off electrical solenoid 100 with a novel and flexible sealing system 101 capable of providing leak-free sealing over a wide range of temperatures and pressures. Embodiments of the invention balance the various conflicting design challenges by offering a sealing solution that is largely geometry-based instead of material compliance based.

A surface of revolution having an axis through a center of a sealing ring, preferably a spherical surface, acting as the sealing face formed on a proximal end of a piston seals against an inside diameter of a sealing ring. The alignment of the sealing face and the sealing ring is reliably and reproducibly ensured by aligning the centerlines of the piston, the sealing face, an insert which forms the sealing ring and the sealing ring along a common centerline.

In a preferred embodiment, the piston is fit tightly within the bore of the solenoid's valve body and the alignment of the centerlines of the various-components of the solenoid, including the insert, is ensured by co-machining of the bores in which the piston and the insert are fit.

In an alternate embodiment, where it may be impractical to have a tight piston-to bore fit, a piloting bearing is positioned within the bore of the valve body to form a first bore in which the piston is tightly fit and a second bore in which the insert is fit. The first and second bores are co-machined and thus have a common centerline. The sealing face and the sealing ring centerlines are aligned along the common centerline of the piloting bearing thus ensuring reliable mating and sealing each time.

Application requirements to handle various fluids, pressures, temperatures, flow rates, life expectancies and costs can be accommodated by changing the spherical sealing face's features, including material, diameter, sphericity, surface finish, and coatings, if any. Further, selection of the elastomeric material used for either the sealing face or the insert permits the solenoid to be used in high pressure, high temperature situations with small molecule gases such as hydrogen. Typically, the choice of a polyimide having a tensile strength greater than 30,000 psi as the insert material would permit use with small molecule gases under these conditions.

### BRIEF DESCRIPTION OF THE DRAWINGS

FIG. 1 is a longitudinal section view of a prior art solenoid;

FIGS. 2a-e, are partial longitudinal sectional views illustrating prior art sealing systems for solenoids, more particularly,

FIG. 2a illustrates a prior art raised, radiused metal seating lip in combination with a deep elastomeric seal commonly used with plastic or rubber seals at low pressure;

FIG. 2b illustrates a prior art flat seating lip in combination with a shallow elastomeric seal commonly used with rubber seals at low pressure;

FIG. 2c illustrates a prior art narrow, flat seating lip in combination with a relatively deep elastomeric seal commonly used with gases at higher pressures;

FIG. 2d illustrates a prior art inverted conical seat in combination with a deep, protruding conical seal typically used with rubber seals at lower pressure and plastic seals at higher pressure; and

FIG. 2e illustrates a prior art raised radiused sealing lip formed on the piston in combination with a deep elastomeric seat on the valve body,

FIG. 3a is a longitudinal sectional view of a sealing system, according to an embodiment of the invention, shown in a closed position;

FIG. 3b is a longitudinal sectional view of the sealing system, according to FIG. 3a, shown in an open position;

FIG. 3c is an exploded partial longitudinal sectional view according to FIGS. 3a and b illustrating alignment of individual component centerlines along a common centerline;

FIGS. 4a-b are partial section views of the sealing face and the sealing ring illustrating a finite plastic deformation of the elastomeric, more particularly

FIG. 4a illustrates an elastomeric sealing face and a metal insert and sealing ring; and

FIG. 4b illustrates a metal sealing face and an elastomeric insert and sealing ring;

FIGS. 5a-c are partial longitudinal sectional views according to FIG. 3a, illustrating a variety of sizes of ball bearings to accommodate a variety of sealing diameters;

FIGS. 6a-c are partial longitudinal sectional views according to FIG. 3a each illustrating an alternative embodiment for retaining a ball bearing onto a proximal end of the piston for forming the hemispherical piston sealing face, more particularly

FIG. 6a illustrates a threaded retaining collar installed on the proximal end of the piston for retaining the ball bearing thereon

FIG. 6b illustrates insertion of the ball bearing from a distal end of the piston and a retainer for retaining the ball bearing therein; and

FIG. 6c illustrates a piston having a hemispherical face formed on the proximal end of the piston;

FIG. 7a is a longitudinal sectional view of an alternate embodiment of the sealing system illustrating a piloting bearing to guide the piston as an alternative to tight piston-to-bore fit; and

FIG. 7b is an exploded partial longitudinal sectional view according to FIG. 6a illustrating alignment of individual component centerlines along a common centerline.

### DETAILED DESCRIPTION OF EMBODIMENTS OF THE INVENTION

Prior Art

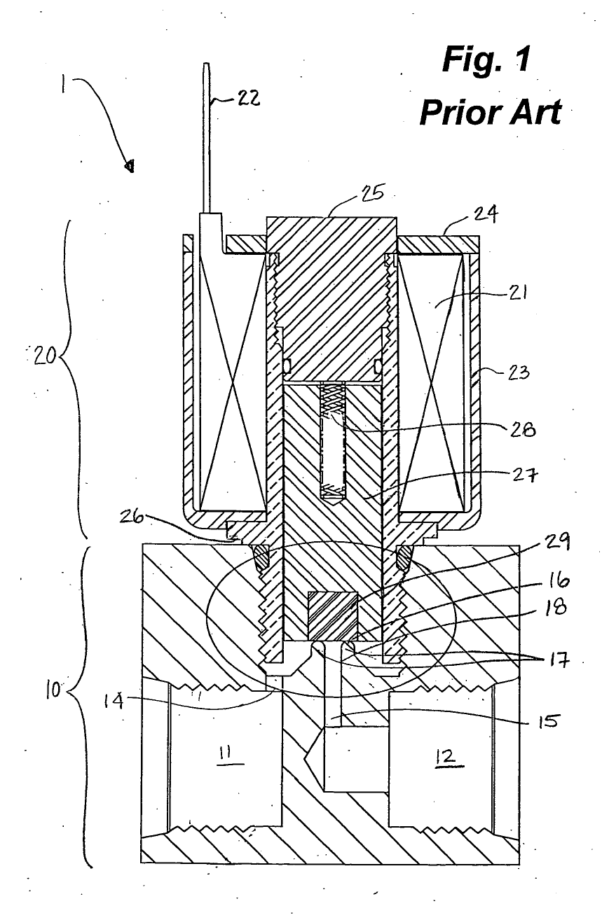

As illustrated in FIG. 1, a typical, conventional solenoid 1, comprises a valve body 10 and an operator 20. The valve body 10 includes an inlet port 11, an outlet port 12, and an operator port 13. The inlet and outlet ports 11, 12 are in fluid communication with the operator port 13 through first and second passages 14, 15, respectively. In operation, the controlled fluid passes from inlet port 11 to operator port 13.

The operator 20 includes a coil 21 having electrical terminals 22, a coil cover 23 and a flux washer 24. Both the coil cover 23 and the flux washer 24 are made of magnetic steel and act to provide magnetic flux with a low resistance, return path. A core tube or bore 26 is made of a non-magnetic metal and houses a piston 27, which is magnetic. A return spring 28 sits in the center of the piston 27 and acts to urge the piston 27 towards its closed position, when the coil 21 is de-energized. The piston 27 also includes the elastomeric seal 29.

If the prior art solenoid 1 is energized, the fluid from ports 11,13 passes by a seating face 16 and exits the valve through outlet port 12. As shown, in one prior art embodiment, the seating or sealing face 16 is that of a raised, radiused lip 17, the lip 17 being formed at an inner edge 18 of the seating face 16. The radiusing serves to minimize insults, such as cutting, to the elastomeric seal 29. Further, the size of the lip's radius is chosen to produce the required amount of sealing pressure or stress at the face of seal 29.

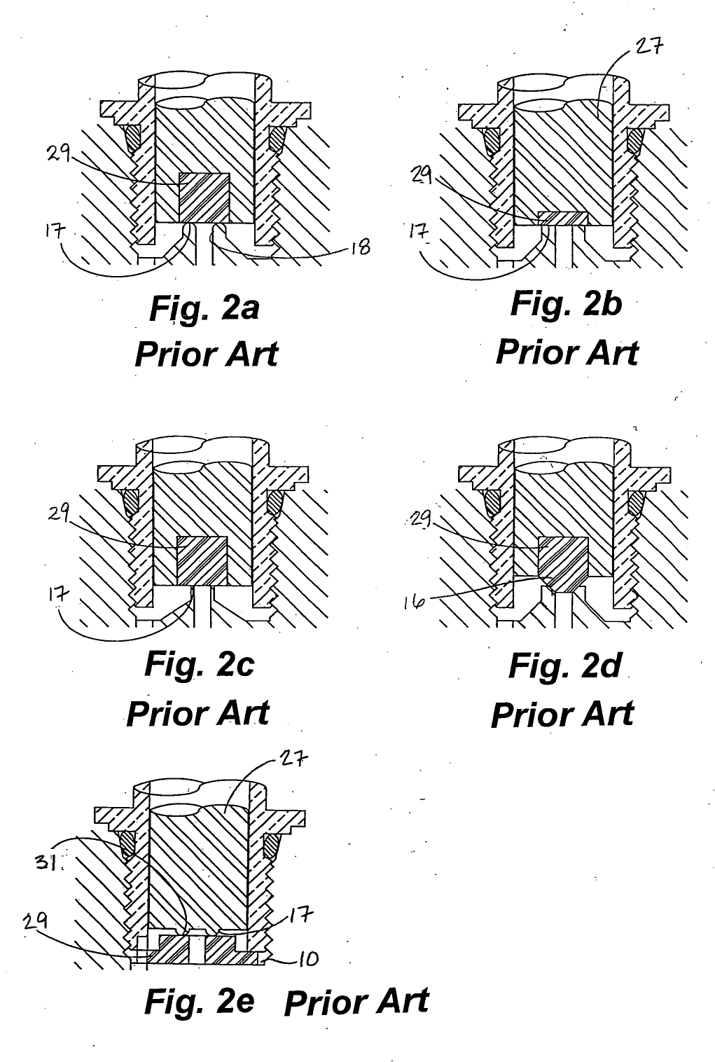

FIGS. 2a-2e illustrate five common, prior art solenoid sealing systems. Notably, the features illustrated can be, and are routinely intermixed based on application requirements and designer preferences. In other words, the features as illustrated are not necessarily used solely in the combinations shown. FIG. 2a illustrates the prior art sealing system as shown in FIG. 1. The notable features in FIG. 2a are a raised, radiused metal lip 17 formed at an inner edge 18 of the seating face 16, and a relatively deep elastomeric seal 29. The increase in the depth of seal 29 acts to reduce the strain in the elastomer. The configuration shown in FIG. 2a is typically used when the seal 29 is made of an engineering plastic or rubber and when the operating pressure to which the solenoid 1 will be subjected is relatively low.

FIG. 2b illustrates a prior art configuration having a shallow elastomeric seal 29 and a flat seating lip 17 which is typically used with rubber seals 29. Very shallow seals 29 are often bonded to the piston 27, which is typically metal. The flat seating lip 17 is most commonly used for lower operating pressures. In some applications, the seat lip 17 is modified to have an included angle greater than 180°, for example, shaped like the top of a shallow cone (not shown).

FIG. 2c illustrates another prior art variant wherein the elastomeric seal 29 is relatively deep and the seating lip 17 is flat and very narrow. The very narrow lip 17 is most commonly used with gases and at higher pressures.

FIG. 2d illustrates a prior art variant having an inverted, conical seating face 16 and a deep, protruding conical elastomeric seal 29, typically used with rubber seals at lower pressure and plastic seals at higher pressures.

FIG. 2e illustrates a prior art variant which is a mirror image of FIG. 2a. The raised, radiused sealing lip 17 is formed on a face 31 of the piston 27. The elastomeric seal 29 is positioned on the valve body 10. Similarly, all of the variants shown in FIGS. 2a-2e and the various combinations, could be made in a mirror-image, through placement of the seating lip 17 and the seal 29 and/or material type.

### Embodiments of the Invention

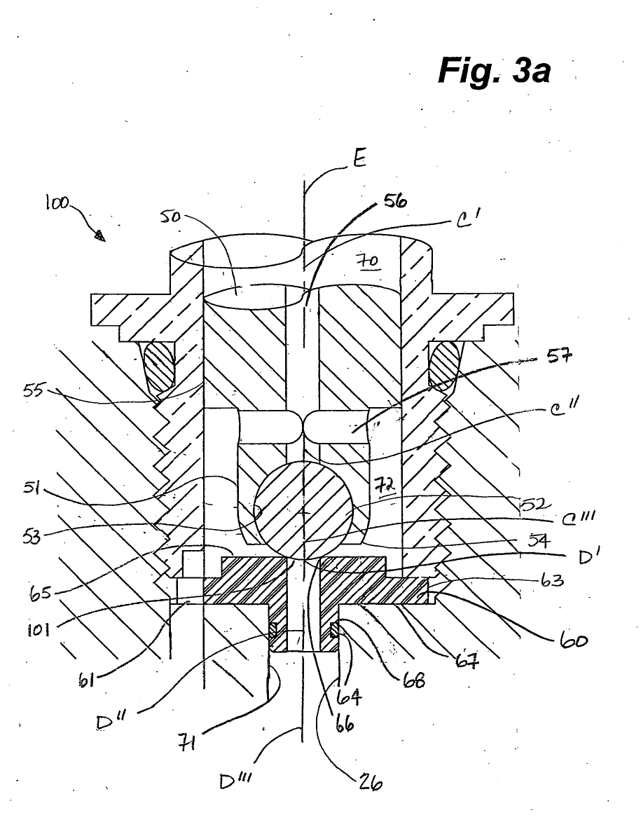

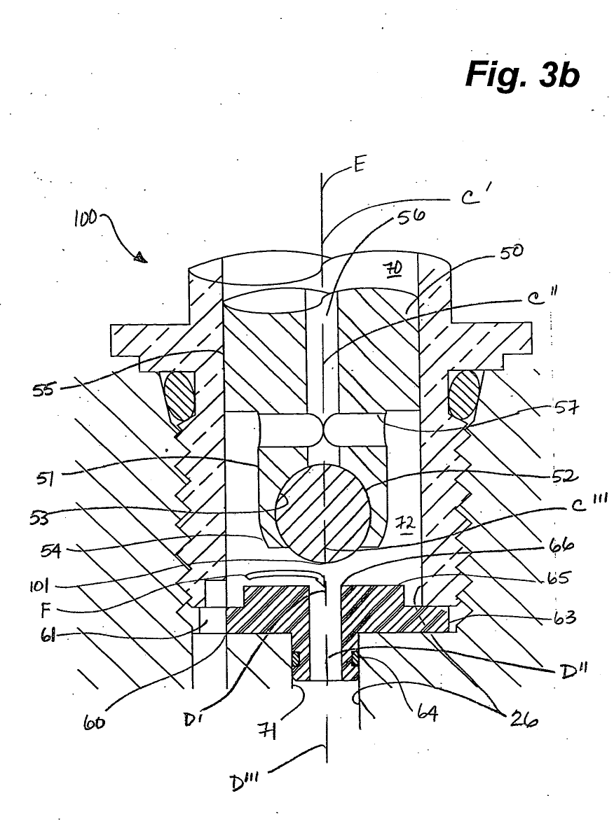

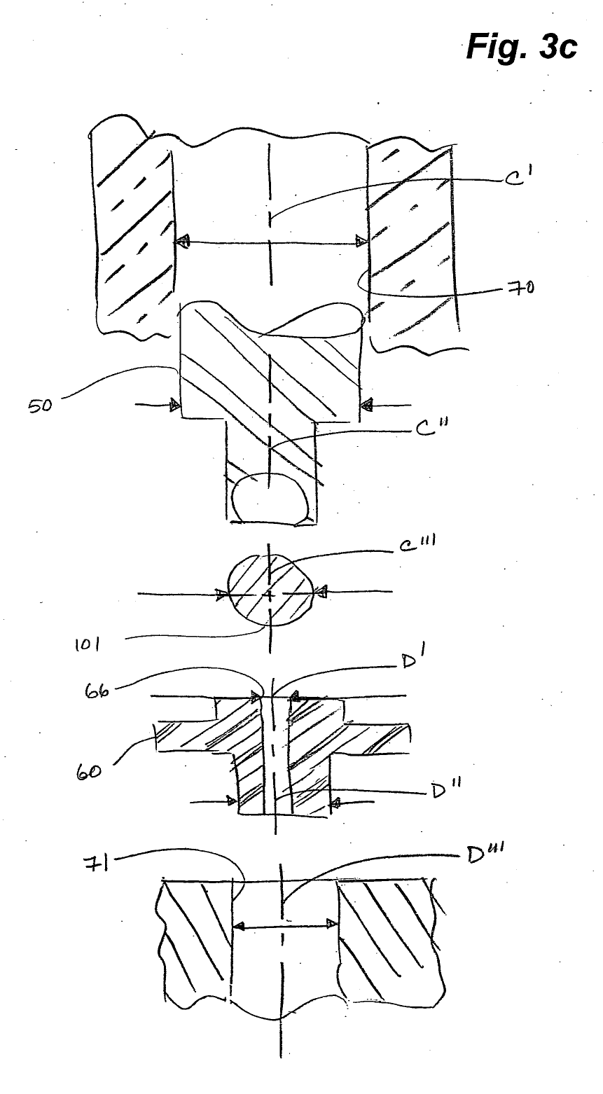

As shown in FIGS. 3a-b, 4a-c, 5a-c and 6, embodiments of a solenoid 100 of the present invention each comprise a piston 50 axially moveable within a precision core bore 26 formed in the valve body 10. The piston 50 further comprises a sealing face 101, being a surface of revolution and typically a hemispherical or ball-nosed face, which seals against an elastomeric seat, typically formed as an insert 60 fit to the precision core bore 26.

Having specific reference to FIGS. 3a (closed position) and 3b (open position) and in an embodiment of the invention, the insert 60 is washer-shaped. A ball bearing 52, used to form the hemispherical face 101, seats on an inner diameter or sealing ring 66 of the insert 60 in the closed position. By appropriate selection of the insert 60 material and the insert's circumference, the insert's strain range is constrained to stay within acceptable limits, to remain elastic across a wide range of pressures.

As shown in FIG. 3c, a centerline C′ of the valve body 10, a centerline C″ of the piston 50 and a centerline C′″ of the hemispherical face 101 are aligned along a first common centerline C of the precision core bore 26. Similarly, a centerline D′ of the sealing ring 66, a centerline D″ of the insert 60 and a centerline D′″ of the valve body 10 are also aligned along a second or common centerline D, of the precision core bore 26. The common centerlines C and D are also aligned to form a common centerline E (FIG. 3b), thus ensuring alignment of the sealing face 101 in the sealing ring 66 for repeated, reliable sealing in the closed position following each stroke of the piston 50 within the core bore 26.

More specifically, in the embodiment shown, the solenoid piston 50 is manufactured having a smaller diameter 51 at a proximal end 54 of the piston 50, The proximal end 54 contains a hemispherical pocket 53 into which a ball bearing 52 is inserted. The piston's proximal end 54 is subsequently crimped or rolled over at least a portion of the ball bearing 52, typically cold formed, permanently clinching the ball bearing 52 in the sealing end 54 of the piston 50, without materially deforming the ball bearing 52. A primary outer diameter 55 of the piston 50 is adjusted to provide a tighter than normal fit within a first bore portion 70 of the core tube 26 and thus acts to improve guidance of the piston 50 within the first bore 70. Typical room temperature diametral clearance with a ⅜″ piston would be in a range of about 0.004″ to about 0.002″ depending upon the specification application and manufacturing considerations. With this level of guidance and with a common centerline C, the ball bearing 52 predictably centers itself in the sealing ring 66 of the insert 60, which is fit within a second bore portion 71 of the core bore 26, so as to effectively and repeatedly seal leak-tight therebetween.

In an embodiment of FIGS. 3a-c, to further ensure the first and second bores 70,71 are aligned along the common centerline E, the first and second bore's 70,71 are co-machined.

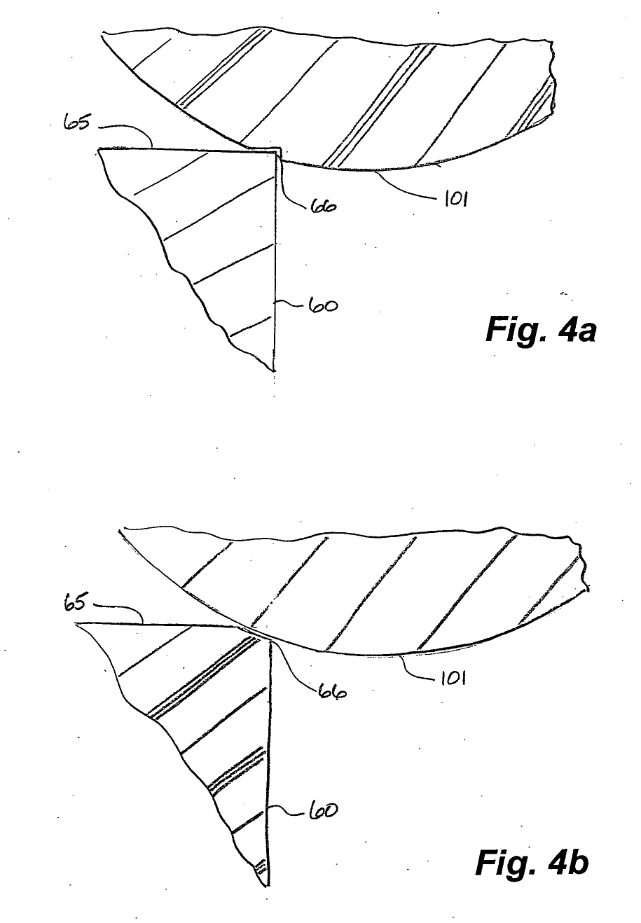

The hemispherical face 101 may be formed using a variety of different manufacturing methods. In one embodiment, as shown in FIGS. 4a-4c, the ball-nosed piston face 101 is created by imbedding a commercial ball bearing 52 in an end of the piston 50. By selecting an appropriate size, grade and material for the ball bearing 52, a variety of design specifications are accommodated. Notably, ball bearings 52 are high volume production items available in a wide variety of sizes, grades and materials. As a result, the surface geometry and finish of the ball bearings 52 are improved by more than a 10:1 factor over conventional techniques such as machining, turning lapping or grinding.

Specifically, standardized grading allows ball bearings 52 to be readily specified and purchased as commodities, based on sphericity and surface finish. For example, ball bearings 52 are available with sphericities ranging from ±3 to ±200μ-inch and surface finishes from 0.5 to 8μ-inch, which both correspond to Class 3 to Class 200 grades. By comparison, conventional machining methods would typically generate geometry accuracies of only ±500 to 4000μ-inch and surface finishes of 32 to 100μ-inch. A comparison of the specifications are shown in Table A.

TABLE A

| | Values in micro- | | | |
|---|---|---|---|---|
| | inches (μ-inch) | | Values in Micro-meters (μ) | |
| Production | | Surface | | Surface |
| Means | Geometry | Finish | Geometry | Finish |
| Conventional | ±500 to 4000 | 32 to 100 | 12.7 to 102 | 0.8 to 2.5 |
| machining | | | | |
| Ball bearing | ±3 to ±200 | 0.5 to 8 | .03 to 5.08 | 0.01 to 0.2 |

Geometry and surface finish specifications are particularly relevant to providing optimum sealing for specific application requirements, such as small volume gas at high pressure. For example, as previously stated herein in the background of the invention, the maximum allowable leak rate for a 350 bar (5075 psi) hydrogen valve would occur if a surface imperfection of 5μ-inch existed. Clearly, achieving the required seal performance using conventionally machined parts is questionable or beyond the capability of the conventionally machined parts. Thus, using even the best machined parts available, the ability to seal would rely largely on the elastomer seal's compliance to offset the potential leak past native surface imperfections.

By contrast, using the ball bearing 52, geometry alone is likely sufficient to provide the required performance. A Grade 3 ball bearing 52 having a sphericity of ≦±3μ-inch and a surface finish of ≦0.5μ-inch may be sufficient to seal leak-tight against a non-compliant seal 60 of comparable quality. Against a compliant seal 60, an even lower quality ball bearing 52 is likely still capable of sealing.

In embodiments of the invention, ball bearings 52 may be made of materials which include such plastics as nylons, acetyls, polytetrafluoroethylenes (PTFE's), and polyimides and metals including steels, stainless steels and carbides. For each application for which the solenoid 100 would be used, the material is selected based on the geometry, fluid, pressures and temperatures to be accommodated.

Another alternative is to select an elastomeric or plastic for the insert 60 specific for the intended use. Engineering plastics are now available which have a wide range of tensile strengths, compressive strengths and creep tendencies. As an extreme example, polyimides have tensile strengths greater than 30,000 psi and virtually no appreciable creep tendencies would occur in service. Thus, those materials can be used, unsupported, in very high pressure solenoids.

Insert 60 comprises a body 67 having a communicating path 61 which delivers input fluid to a control chamber (not shown). An outlet bore 62 delivers the allowed flow to an outlet port (not shown). A shoulder or flange 63 or other retention means formed on the body 67 aids in holding the insert 60 in place in the second bore 71. A flat upper surface 65 of the insert 60 intersects the outlet bore 62, forming preferably, a sharp edged circle which acts as the sealing ring 66 for the ball bearing 52. An O-ring 64 or other sealing means, installed in a lower end 68 of the body 67, prevents inlet gas from by-passing the solenoid 100 and reaching the outlet port directly.

As shown in FIG. 3b, an arrow F indicates the direction of flow for the most common configuration in which fluid pressure acts to help close the solenoid 100 when the coil (not shown) is de-energized. The inlet and outlet ports (not shown) could however be reversed causing fluid pressure to act to open the solenoid 100. Notably, such configurations have lower useful operating pressure ranges. Particularly, at some pressure the solenoid 100 will “blow open” even though the coil is de-energized.

Having reference to FIGS. 4a and 4b, assuming no geometry or surface imperfections in ball 52 and sealing ring 66, a reliable and enduring leak-tight seal would only occur if there were no deformation of the upper surface 65 of the insert 60. In practice, some imperfections are allowed in order for the solenoid 100 to be economically viable. Accordingly, some deformation of the sealing ring 66 and/or ball bearing 52 is required to null out the effect of such imperfections. To do so, the sealing ring's circumference (sealing area) and material are chosen so that the required deformation of the sealing ring 66 is within a finite and plastic range of the material in response to high point loadings. However, as long as the material remains in the elastic range thereafter, the insert 60 and sealing ring 66 will retain their original shape and function properly to seal at all design pressures. Stated from the opposite perspective, if the design were to cause the insert 60 to yield with each successive use, the ball bearing 52 would form an increasingly deeper witness mark in the insert 60 and eventually stop sealing.

It will be appreciated that the concept disclosed herein has significant flexibility. Perhaps most notable, as shown in FIGS. 4a and 4b, is the ability to switch which member, the ball bearing 52 or the insert 60, is metal and which is elastomer. For example, for a 350 bar gas application, the ball bearing 52 might be made from virgin PTFE (e.g. TEFLON®) and the insert 60 made from brass. For a 700 bar gas application, the ball bearing 52 might be made from tungsten carbide and the insert 60 made from a polyimide, such as Dupont SCP-50000 having a tensile strength of approximately 32600 psi. For a 5 bar liquid application, the ball bearing 52 might be made from acetal, such as DELRIN®, available from Dupont Canada, and insert 60 machined, cast or molded as an integral part of a metal or plastic valve body.

In another aspect, with a tight piston-to-bore fit, a typical piston 50 would be very sluggish to operate. That is, when opening or closing, it would take a noticeable amount of time for the fluid to move from one end of the piston 50 to the other through a small radial gap 72. Accordingly, a central vent passage 56, 57 is provided to allow essentially instantaneous movement of the fluid and thus rapid piston motion. Specifically, axial bore 56 and radial cross drilling 57 provide a low restriction fluid connection path between distal (not shown) and proximal 54 ends of the piston 50. Thus, during piston 50 movement, the displaced fluid can move quickly, allowing unrestricted movement of the piston 50. For example, testing confirms that with bores 56 and 57 being 1.5 mm, the motion of a ⅜″ piston is unimpeded for total diametral clearances as small as about 0.0004″.

Alternately, the vent 56,57 may be an axial slot (not shown) milled or broached in the outer diameter of the piston 50.

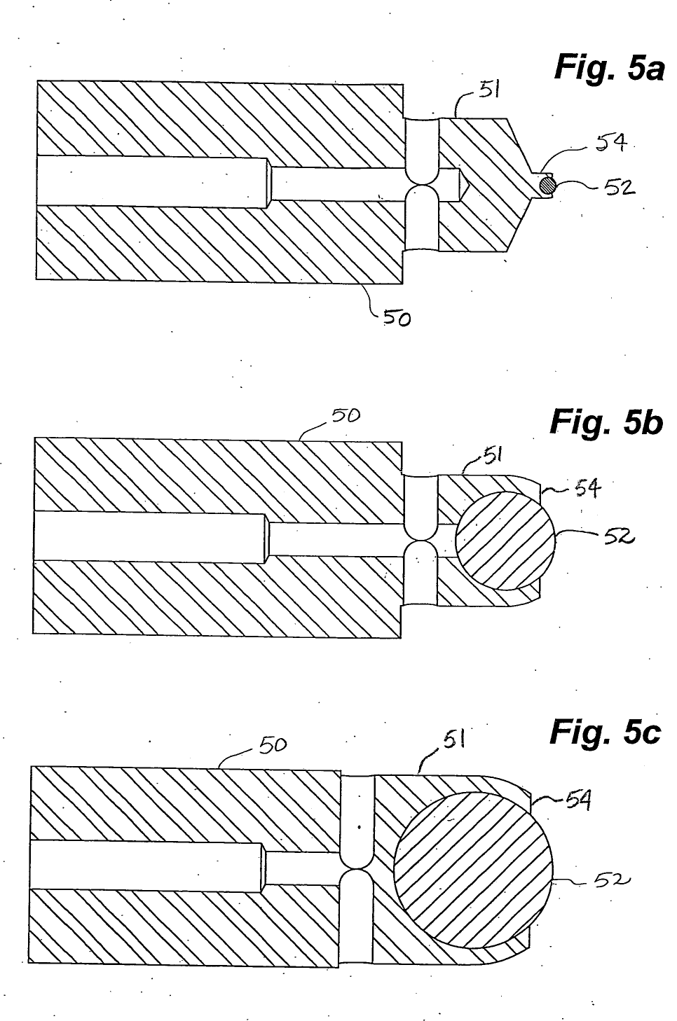

FIGS. 5a-c illustrate the flexibility of the concept to accommodate various sealing diameters. FIGS. 5a-c illustrate, for example, three ball bearing 52 sizes spanning a 9.5:1 diameter ratio (90:1 flow capability) range when used in a single piston size (⅜″ or 9.52 mm). As shown in FIG. 5a, the diameter of the ball bearing 52a is 1/32″ (0.79 mm). As shown in FIG. 5b, the ball bearing 52b is 3/16″ (4.76 mm). As shown in FIG. 5c, the ball bearing 52c is 19/64″ (7.54 mm). The smallest practical diameter that can be utilized is most likely limited to the commercial availability of ball bearings 52. In the 1/32″ size, the ball bearings 52 are readily available, the pistons 50 can be machined using conventional techniques, and the axial cold forming to clinch the ball bearings 52 is not too delicate to be practical using inexpensive arbor presses.

Within a specific piston 50 size, the largest practical ball bearing 52 size may be limited by either fluid motion considerations or the strength requirements for the clinching portion of the piston 50. As noted previously, a path, such as passages 56 and 57, is provided for movement of displaced fluid as the piston 50 moves. As the ball bearing 52 size increases, the outside diameter (51 in FIGS. 3a-b) of the proximal end 54 of the piston 50 increases. At some point, as diameter 51 approaches the primary bore diameter (55 in FIGS. 3a-b), the piston-to-bore clearance in that area begins to restrict fluid motion and the piston 50 no longer moves freely. As shown in FIG. 5c, diameter 51 is 0.007″ (0.18 mm) smaller radially than is diameter 55. At that size, fluid motion is unrestricted. With any ball bearing 52 size, the wall thickness of the proximal clinched end 54 is chosen so that the wall does not yield or break during service. Typically, the thinnest possible wall thickness is desired to minimize both fluid flow restriction and the potential of deforming the ball bearing 52 during the clinching process.

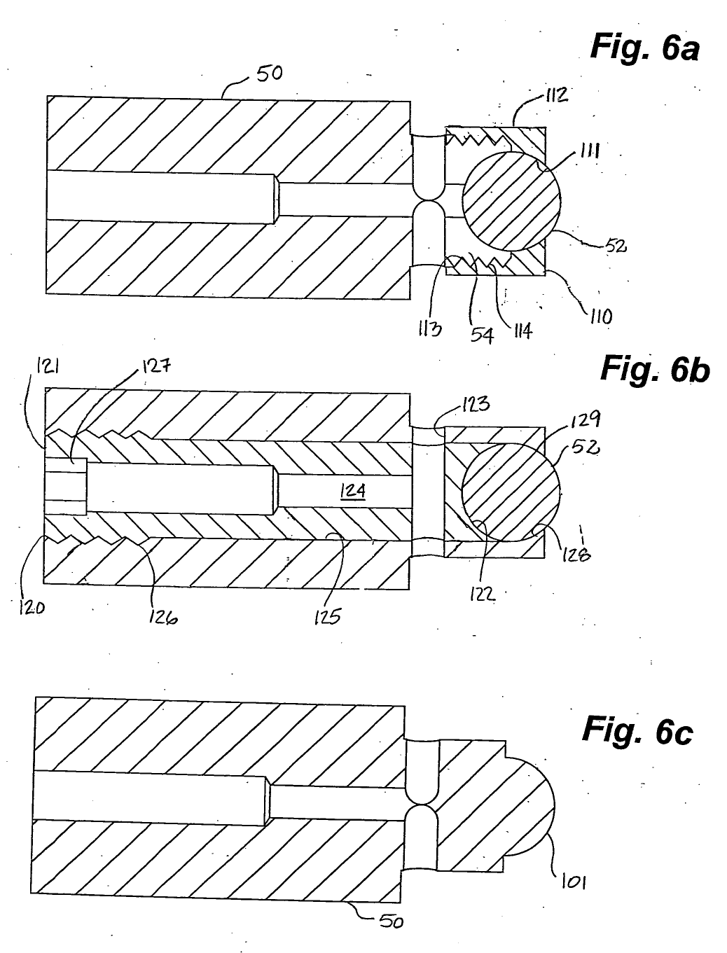

It will be appreciated that in some very sensitive applications, it may be preferable to retain the ball bearing 52 with an even lower assembly force. FIGS. 6a-c illustrate alternate embodiments of the invention wherein the hemispherical face 101 or ball bearing 52 is incorporated with the piston 50 other than by cold forming.

As shown in FIG. 6a, a threaded retaining collar 110 70 is installed from the proximal end 54 of the piston 50 and acts to retain the ball bearing. Retainer 110 comprises a spherical segment 111 which engages the outside diameter of ball bearing 52, an appropriate outside diameter 112 for adequate strength, and threads 113 for retaining the collar 110. The piston 50 is modified to add appropriate threads 114 on the proximal end 54 of the piston 50 and to truncate the hemispherical socket 53 so as to conform to the specifications of the ball bearing 52 and retainer 110.

FIG. 6b illustrates another alternative, wherein the ball bearing 52 is installed from a distal end 120 of the piston 50 and held in place by retainer 121. Retainer 121 includes a spherical segment 122 which clamps the ball bearing 52, cross drilling 123 and axial drilling 124, which correspond to passages 56 and 57 in FIG. 3, an appropriate piloting diameter 125, appropriate threads 126, and a hex socket 127 or other means to tighten the retainer 121. The piston 50 is modified by the addition of female threads to mate with threads 126, by the addition of the pilot bore diameter 125 and by the formation of a sector 128 of the hemispherical pocket 122 against which a proximal side 129 of ball bearing 52 rests.

As shown in FIG. 6c and for use in some applications where the surface finish and sphericity requirements of the hemispherical face 101 can be met with conventional machining or turning practices, the hemispherical end 101 can be machined into the piston 50 itself.

For some applications it may be impractical to use the tight piston-to-bore fit previously disclosed. Nonetheless, accurate guidance is required or the ball bearing 52 may not seat properly on the sealing ring 66 all of the time, creating random leaks. Further, the elastomeric material may be slowly machined away by random off-center impacts, resulting in reduced long term durability.

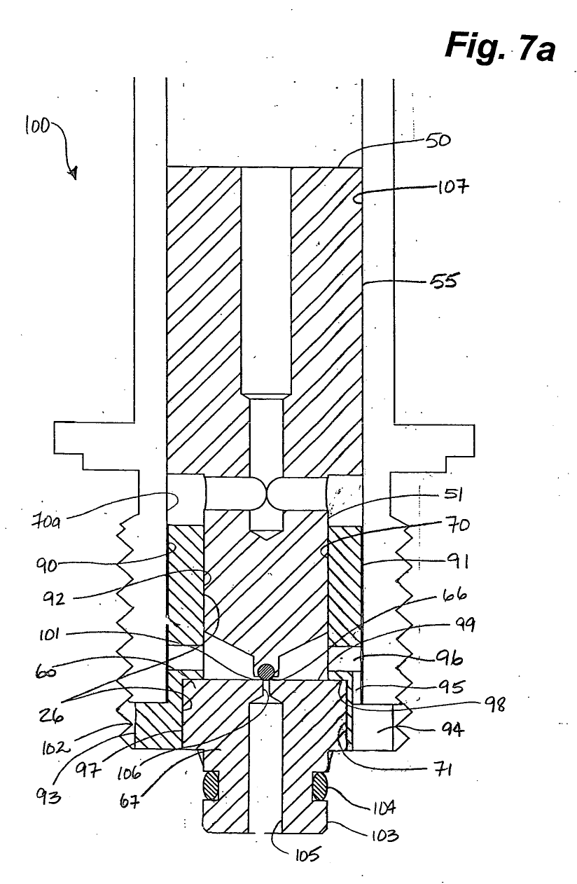

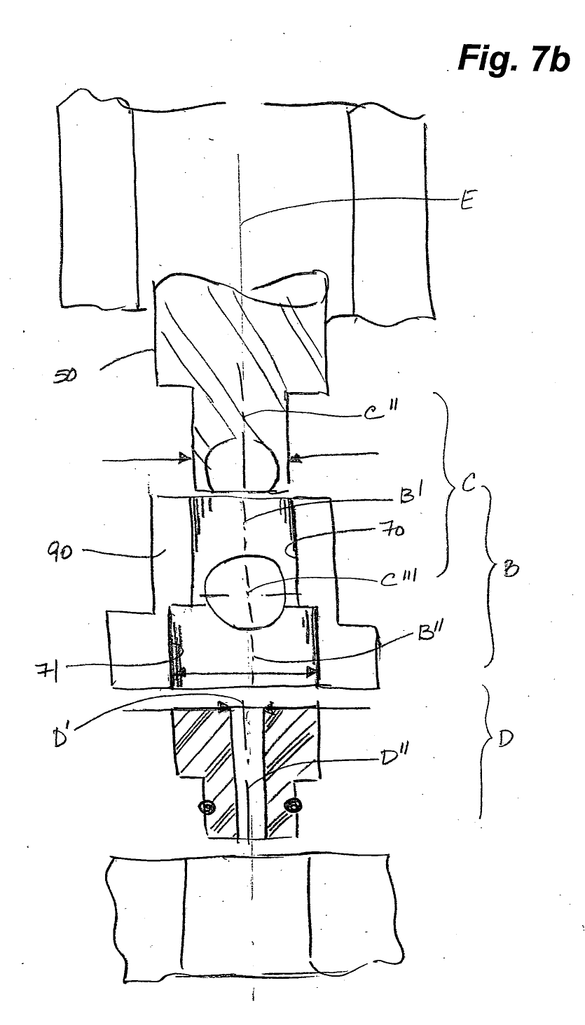

As shown in FIGS. 7a-b and where impractical to use the tight piston-to-bore fit, an alternative embodiment incorporates a piloting bearing 90 which is positioned within the precision core bore 26 of the valve body 10 and forms the first 70 and second 71 bores in which the piston 50 is axially moveable. The piloting bearing 90 maintains the piston 50, the hemispherical sealing face 101 and the insert 60 along the common centerline E. In this embodiment, the piloting bearing 90 pilots or guides the piston's hemispherical face 101 onto the sealing ring 66 of the insert 60.

As shown in FIG. 7b, the centerline C″ of the piston 50 and the centerline C′″ of the hemispherical face 101 are aligned along the common centerline C. Similarly, the centerline D′ of the sealing ring 66, the centerline D″ of the insert 60 are also aligned along the common centerline D. Further, a centerline B′ of the first bore 70 and a centerline B″ of the second bore 71, both formed by the piloting bearing 90, are aligned along a common centerline B. The common centerlines C, D and B are aligned to form the common centerline E, thus ensuring alignment of the sealing face 101 in the sealing ring 66 for repeated, reliable sealing in the closed position following each stroke of the piston 50 within the core bore 26.

In a preferred embodiment, the piloting bearing 90 provides guidance for the piston 50 along the length of the piston's proximal reduced diameter portion 51. Piloting bearing 90 has an outside diameter 91 appropriate to provide clearance within the first bore's inner diameter 70a under all conditions. The effective inner diameter 92 of the first bore 70 at the piloting bearing's location is selected to provide a relatively tight fit to the piston 50 and the required guidance to piston diameter 51 to align the hemispherical sealing face 101 with the sealing ring 66 along common centerline C. The piloting bearing 90 further comprises a flange 93 having a diameter sufficient to clear the valve body's port thread's minor diameter 102 and an inlet passage 94, 95, 96 for delivering inlet gas to the operator chamber. Further, the piloting bearing 90 forms the second bore 71 which closely fits to the insert's 60 diameter 97. A seating face 98 serves to clamp the insert 60 in place by resting against an upper flat face 99 of the insert 60. The insert 60 further comprises a lower diameter 103 for mating with a lower bore (not shown) in the valve body 10, an o-ring 104 or other sealing means for sealing the lower diameter 103 therein and an outlet bore 105 which connects to the control bore 106. The primary diameter 55 of the piston 50 is adjusted so as not to contact an upper valve body bore 107 under the worst case which includes a combination of tolerance stack-ups and temperature extremes. Thus, the piston 50 remains on the same common centerline C as the insert 60 and is capable of reliably sealing on every closure event seal.

A sharp edged intersection 108 forms the sealing ring 66 where bore 106 and face 99 meet. A lower flat face 109 rests against the bottom of the valve body's operator port (not shown).

It can be appreciated that for some applications, piloting bearing 90 and insert 60 may be integrated into a single part, being either metal or plastic.

Further, the materials used for the ball bearing 52 and the insert 60 may be reversed, the ball bearing 52 being an elastomeric and the insert 60 and piloting bearing 90 being metal.

1. A sealing system for a solenoid comprising:
a valve body having a first bore having a first centerline and a second bore having a second centerline, the first and second centerlines being aligned as a substantially common centerline;
a piston having a sealing face being a surface of revolution about an axis, the piston being axially moveable within the first bore and operable therein between an open and a closed position, both the piston and the axis of the surface of revolution having centerlines common to the first centerline; and
an insert comprising a sealing ring having a sharp inner edge for co-operating with the hemispherical seal for stopping a flow of fluid therepast when the piston is in the closed position, the insert having a body being fit within the second bore, both the insert body and the sealing ring having centerlines common to the second centerline
wherein one of either the hemispherical sealing face or the insert is formed of an elastomeric material, the elastomeric material selected to be deformable within a limited plastic range which will not yield further at design pressures, for repeatedly achieving leak-tight sealing in the closed position.

2. The sealing system as described in claim 1 wherein the surface of revolution is a hemispherical sealing face.

3. The sealing system as described in claim 2 wherein the hemispherical sealing face is a ball bearing inset in a proximal end of the piston.

4. The sealing system as described in claim 1 wherein the first and second bores are co-machined for forming the common centerline.

5. The sealing system as described in claim 1 wherein the piston is fit tightly within the first bore for guiding the piston along the common centerline.

6. The sealing system as described in claim 1 further comprising a piloting bearing positioned in the valve body and forming the first and second bores, the piloting bearing being fit tightly about at least a portion of the piston for guiding the piston along the common centerline.

7. The sealing system as described in claim 3 wherein the ball bearing is held within the proximal end of the piston by cold forming.

8. The sealing system as described in claim 3 wherein the ball bearing is held within the proximal end of the piston by a threaded retainer ring positioned about the ball bearing.

9. The sealing system as described in claim 3 wherein the ball bearing is inserted into an axial drilling in the piston and held therein at the proximal end of the piston by a retainer.

10. The sealing system as described in claim 1 further comprising:
a proximal end of the piston having a reduced diameter relative to a primary diameter of the piston.

11. The sealing system as described in claim 10 further comprising positioned in the first bore and fit tightly about the reduced diameter portion of the piston for guiding the piston in the first bore along the common centerline.

12. The sealing system as described in claim 1 further comprising a vent passage formed in a proximal end of the piston for forming a fluid connection path between a distal end and the proximal end of the piston for permitting unrestricted movement of the piston in the first bore.

13. The sealing system as described in claim 1 wherein the elastomeric material is selected from the group consisting of nylons, acetyls, polytetrafluoroethylenes and polyimides.

14. The sealing system as described in claim 1 wherein the sealing face is metal and the insert is an elastomeric material.

15. The sealing system as described in claim 1 wherein the sealing face is elastomeric material and the insert is metal.

16. The sealing system as described in claim 14 wherein the metal is selected from the group consisting of steel, stainless steel and carbide.

17. The sealing system as described in claim 15 wherein the metal is selected from the group consisting of steel, stainless steel and carbide.

18. The sealing system as described in claim 14 wherein the elastomeric material is selected from the group consisting of nylons, acetyls, polytetrafluoroethylenes and polyimides.

19. The sealing system as described in claim 15 wherein the elastomeric material is selected from the group consisting of nylons, acetyls, polytetrafluoroethylenes and polyimides.
